(19) United States
(12) Patent Application Publication
(10) Pub. No.: US 2013/0092256 A1
(43) Pub. Date: Apr. 18, 2013

(54) FLOW RATE CONTROL DEVICE, DIAGNOSTIC DEVICE FOR USE IN FLOW RATE MEASURING MECHANISM OR FOR USE IN FLOW RATE CONTROL DEVICE INCLUDING THE FLOW RATE MEASURING MECHANISM AND RECORDING MEDIUM HAVING DIAGNOSTIC PROGRAM RECORDED THEREON FOR USE IN THE SAME

(71) Applicant: Horiba Stec, Co., Ltd., Kyoto-shi (JP)

(72) Inventors: Tadahiro Yasuda, Kyoto-shi (JP); Shigeyuki Hayashi, Kyoto-shi (JP); Akito Takahashi, Kyoto-shi (JP); Tetsuo Shimizu, Kyoto-shi (JP)

(73) Assignee: HORIBA STEC, CO., LTD., Kyoto-shi (JP)

(21) Appl. No.: 13/651,061

(22) Filed: Oct. 12, 2012

(30) Foreign Application Priority Data
Oct. 14, 2011 (JP) 2011-227398

(51) Int. Cl. G05D 7/06; G01F 1/34

(52) U.S. Cl. 137/487; 137/487.5; 73/861.42

(57) ABSTRACT

The flow rate control device is provided with: a fluid resistor provided on the flow channel; a pressure sensor provided in any one of an upstream side or a downstream side of the fluid resistor; a stable state judging part configured to judge, based on the measurement flow rate value or a measurement pressure value measured by the pressure sensor, whether or not a state of the fluid flowing through the flow channel is in a stable state; and an abnormality diagnosing part configured to diagnose an abnormality of the measurement flow rate value based on a variation amount of the measurement pressure value in the case where the stable state judging part judges that the state of the fluid is in a stable state.

### TECHNICAL FIELD

The present invention relates to a flow rate control device and the like having a configuration for diagnosing an abnormality of a measurement flow rate value indicated by a flow rate measuring mechanism for measuring a flow rate of fluid flowing through a flow channel.

### BACKGROUND ART

For example, in manufacturing semiconductor products and the like, it is necessary that a process gas containing raw materials required for deposition is accurately supplied at a target flow rate with high accuracy while a wafer is placed in a chamber of, for example, a chemical vapor deposition (CVD) device.

For controlling a flow rate of, for example, a process gas, a mass flow controller is provided on a flow channel connected to the chamber. A flow channel is formed in this mass flow controller, and the mass flow controller is configured as one package composed of a block body provided with various kinds of flow rate control equipment attached thereto, a flow rate measuring mechanism such as a thermal type flow rate sensor for measuring a flow rate of fluid flowing through the flow channel, a flow rate control valve, and a valve control part configured to control an opening degree of the flow rate control valve so as to reduce an error between a target flow rate value and a measurement flow rate value measured by the flow rate measuring mechanism.

Furthermore, some of the products of the process gas can easily adhere to an inside of a fine sensor flow channel for measuring a flow rate, such as a laminar element for diverting the fluid, and if the products adhere, clogging may occur so that an accurate flow rate cannot be measured in some cases. If a flow rate measurement value measured by the flow rate measuring mechanism is inaccurate, an error may be likely caused in an actual flow rate of the process gas flowing into the chamber even if the flow rate control valve is accurately controlled. Accordingly, it becomes impossible to manufacture a semiconductor having a desired performance.

In order to solve such problems, a flow rate control device, such as a mass flow controller having a configuration for diagnosing, e.g., whether or not such a clogging occurs in a flow rate measuring mechanism that causes an abnormality in a measurement flow rate value, has been conventionally proposed.

For example, a flow rate control device described in Patent Literature 1 is configured to control a process gas at a target flow rate by using a sonic nozzle, wherein a ratio of an upstream side pressure and a downstream side pressure of an orifice is made to be equal to or larger than a predetermined value so that a fluid flow maintains a sonic velocity, and the flow rate control device is provided with a pressure control valve for controlling only a pressure in the upstream side of the orifice in accordance with a target flow rate value. In this configuration, if products of the process gas adhere and the like so that the orifice is clogged or an effective sectional area thereof is changed, it becomes impossible to introduce a process gas at a desired flow rate value. Therefore, a diagnostic circuit is provided for diagnosing an abnormality caused by a clogging of the orifice. This diagnostic circuit compares a first flow rate measurement value outputted from a flow rate measuring mechanism to a second measurement flow rate value measured by a thermal type flow rate sensor, wherein the flow rate measuring mechanism includes a pressure sensor provided in the upstream of the orifice, a temperature sensor similarly provided in the upstream of the orifice, a calculating part for calculating a flow rate of the fluid flowing in the upstream of the orifice using the Bernoulli Expression and by substituting therein a measurement pressure measured by the pressure sensor and a measurement temperature measured by the temperature sensor. Subsequently, if an error between the first flow rate measurement value and the second flow rate measurement value is equal to or larger than an acceptable amount, a signal is outputted indicating a suggestion that the orifice be exchanged. Herein, the first flow rate measurement value obtained by the flow rate measuring mechanism is fed back and used for controlling an opening degree of the pressure control valve.

In other words, in the flow rate control device disclosed in Patent Literature 1, in order to diagnose a clogging in the orifice, the diagnostic circuit is configured to be operative by providing a thermal type flow rate sensor which is not used for feedback control, other than the flow rate measuring mechanism for feedback control.

However, a demand for reducing costs is severe in the field of semiconductor manufacturing. As such, even in the case of a flow rate control device as described above, it is required that clogging of a flow channel and an abnormality of a measurement flow rate value can be accurately diagnosed so as to be able to control flow rate with high accuracy while reducing the number of parts as much as possible.

From this point of view, the flow rate control device of Patent Literature 1, wherein in order to diagnose clogging, it is necessary that a total of four sensors, i.e., a pressure sensor, a temperature sensor and further two temperature sensors for constituting a thermal type flow rate sensor provided upstream of the orifice, be provided on the flow channel, cannot satisfy the demand for reduction in cost and number of parts. On the other hand, if the number of the sensors is simply reduced, it becomes difficult using the above configuration, to precisely diagnose, based on a quantitative evaluation, whether or not the measurement flow rate value used in the feedback control indicates a correct value to an acceptable degree, or to accurately diagnose whether or not clogging actually occurs in the flow channel.

### CITATION LIST

### Patent Literature

Patent Literature 1: JP2000-259255A

### SUMMARY OF THE INVENTION

### Technical Problem

The present invention has been made in consideration of the problems as described above, and an object thereof is to provide a flow rate control device, a diagnostic device for use in a flow rate measuring mechanism or for use in the flow rate control device, which includes the flow rate measuring mechanism, and a recording medium having a diagnostic program recorded thereon for use in the same, capable of accurately diagnosing a malfunction such as a clogging caused in a flow rate device, and an abnormality occurring in a measurement flow rate value, while reducing the number of parts such as sensors used in the flow rate control device.

### Solution to Problem

That is, the flow rate control device of the present invention includes a flow rate measuring mechanism configured to measure a flow rate of fluid flowing through a flow channel, a flow rate control valve provided on the flow channel, and a valve control part for controlling an opening degree of the flow rate control valve so as to reduce an error between a target flow rate value and a measurement flow rate value measured by the flow rate measuring mechanism, wherein the flow rate control device includes: a fluid resistor provided on the flow channel; a pressure sensor provided in any one of an upstream side or a downstream side of the fluid resistor; a stable state judging part configured to judge whether or not a state of the fluid flowing through the flow channel is in a stable state, based on the measurement flow rate value or a measurement pressure value measured by the pressure sensor; and an abnormality diagnosing part configured to diagnose an abnormality of the measurement flow rate value based on a variation amount of the measurement pressure value in the case where the stable state judging part judges that the state of the fluid is in a stable state.

In addition, the diagnostic device of the present invention is used in a flow rate measuring mechanism configured to measure a flow rate of fluid flowing through a flow channel, or is used in a flow rate control device including the flow rate measuring mechanism, wherein the diagnostic device includes:

a fluid resistor provided on the flow channel; a pressure sensor provided in any one of an upstream side or a downstream side of the fluid resistor; a stable state judging part configured to judge, based on the measurement flow rate value or a measurement pressure value measured by the pressure sensor, whether or not a state of the fluid flowing through the flow channel is in a stable state; and an abnormality diagnosing part configured to diagnose an abnormality of the measurement flow rate value based on a variation amount of the measurement pressure value in the case where the stable state judging part judges that the state of the fluid is in a stable state.

With the configuration like this, only one pressure sensor is provided in any one of the upstream side or downstream side of the fluid resistor other than the flow rate measuring mechanism configured to measure a measurement flow rate value to be used for controlling the flow rate control valve, and therefore the number of sensors to be added to the flow rate control device for purposes other than for feedback control can be reduced as compared to the conventional configuration so that an increase in manufacturing cost can be suppressed.

Moreover, the measurement pressure value to be used for the abnormality diagnosing part to judge whether or not an abnormality occurs in the measurement flow rate value is a value which is measured by the pressure sensor when the stable state judging part judges that the fluid is in a stable state, and therefore, for example, a flow rate control error etc. occurring during flow rate control can be eliminated as much as possible. Therefore, the influence of only the occurrence of an abnormality in the measurement flow rate value due to, for example clogging of the flow channel, is easily apparent from the variation amount of the measurement pressure value, so that the diagnostic accuracy of the abnormality diagnosing part can be improved. In other words, even without providing another different type flow rate measuring mechanism in addition to the above flow rate measuring mechanism (e.g., by providing output of the pressure sensor only), an equivalent diagnostic accuracy can be achieved.

As described above, according to the present invention, an abnormality of the measurement flow rate value is diagnosed based on the variation amount of the measurement pressure value when the fluid is in a stable state, whereby the number of sensors necessary for diagnosing an abnormality of the measurement flow rate value is reduced as compared to conventional techniques, and whereby an abnormality diagnosis of a flow rate measurement value can be accurately performed without being affected by the reduction in the number of sensors. Furthermore, since the measurement pressure value reflecting only the abnormality of the measurement flow rate value when the fluid is in a stable state is used as a diagnostic criteria, it is possible to quantitatively evaluate, for example, the degree of an error occurring between the measurement flow rate value and an actual flow rate. That is, the abnormality diagnosing part can, not only make a qualitative determination of whether or not an abnormality occurs in the measurement flow rate value, but also a quantitative determination as to whether or not an abnormality occurring in the measurement flow rate value is within an admissible degree.

A representative concrete configuration for accurately diagnosing an abnormality of the measurement flow rate value in the abnormality diagnosing part may be a simple configuration, wherein the abnormality diagnosing part may be configured to include: a pressure variation amount calculating part for calculating a variation amount of the measurement pressure value; and an abnormality judging part configured to judge if the measurement flow rate value is abnormal in the case where an absolute value of the variation amount of the pressure calculated by the pressure variation amount calculating part is equal to or larger than a predetermined value.

In order to make it possible to quantitatively evaluate an error amount possibly appearing in the measurement flow rate value from the variation amount of the measurement pressure value measured by the pressure sensor so as to enable more precise diagnoses, the abnormality diagnosing part may be configured to include: a flow rate variation amount calculating part for calculating a variation amount of the flow rate of the fluid flowing through the flow channel based on a variation amount of the measurement pressure value; and an abnormality judging part configured to judge that the measurement flow rate value is abnormal in the case where an absolute value of the variation amount of the flow rate calculated by the flow rate variation amount calculating part is equal to or larger than a predetermined value.

In order to render the influence of the abnormality occurring in the measurement flow rate value to appear only in the measurement pressure value so as to be able to properly judge a stable state of the fluid for ensuring a result of the abnormality diagnosis of the measurement flow rate value, the stable state judging part may be configured to judge that the state of the fluid is in a stable state, in the case where a state of an absolute value of the error between the measurement flow rate value and the target flow rate value is equal to or smaller than a predetermined value, for a predetermined time period or more.

As a concrete example of the flow rate measuring mechanism that can detect an abnormality for diagnosis by the abnormality diagnosing part, the flow rate measuring mechanism may be configured as a thermal type flow rate sensor.

In order to make it easy to diagnose an abnormality caused by clogging due to, for example, adhesion of substances contained in the fluid, the thermal type flow rate sensor may be configured to include a laminar flow element provided on the flow channel, and the fluid resistor may be provided separately from the laminar flow element. Specifically, since the fluid resistor is provided independently of the flow rate measuring mechanism, the calculated flow rate value can be less affected by the clogging occurring in the flow rate measuring mechanism. In other words, by providing the fluid resistor independently from the flow rate measuring mechanism, as compared to the case where the laminar flow element and the fluid resistor are not provided independently, the errors occurring in both of the measurement flow rate value and the calculated flow rate value can be distinguished so as to prevent a situation where the determination of the abnormality becomes difficult.

As a further example, in order to make it possible to configure the diagnostic device of the present invention to be appended to an existing flow rate control device, a diagnostic program of the present invention may be installed from, for example, a recording medium such as a computer. Specifically, the diagnostic program of the present invention recorded on the recording medium is for use in a flow rate measuring mechanism including a fluid resistor provided on a flow channel and a pressure sensor provided in any of an upstream side or a downstream side of the fluid resistor and measuring a flow rate of the fluid flowing through the flow channel, or is for use in a flow rate control device including the flow rate measuring mechanism, wherein the diagnostic program includes: a stable state judging part configured to judge whether or not a state of the fluid flowing through the flow channel is in a stable state, based on the measurement flow rate value or a measurement pressure value measured by the pressure sensor; and an abnormality diagnosing part configured to diagnose an abnormality of the measurement flow rate value based on a variation amount of the measurement pressure value in the case where the stable state judging part judges that the state of the fluid is in a stable state.

### Advantageous Effects of Invention

Thus, according to the flow rate control device, in a diagnostic device for use in the flow rate measuring mechanism, or for use in the flow rate control device which includes the flow rate measuring mechanism and recording medium having a diagnostic program recorded thereon for use in the same of the present invention, as a configuration for diagnosing an abnormality, it is sufficient to provide only one sensor other than the flow rate measuring mechanism for outputting the measurement flow rate value to be used in the feedback control. Hence, the number of parts can be reduced so as to suppress the increase of the manufacturing cost. In addition, since the diagnosis of an abnormality of the measurement flow rate value is performed based on a variation amount of the measurement pressure value when fluid is in a stable state, it becomes possible to diagnose an abnormality of the measurement flow rate value with an accuracy equal to or higher than that in a conventional configuration, even in the case where the number of the diagnostic sensors is smaller than that in the conventional configuration.

### BRIEF DESCRIPTION OF THE DRAWINGS

FIG. 1 is a schematic diagram showing a mass flow controller and a diagnostic device in a first embodiment;

FIG. 2 is a schematic graph for explaining an operation of a stable state judging part of the first embodiment;

FIG. 3 is a flowchart showing an operation of the mass flow controller and an operation relating to a diagnosis of the diagnostic device of the first embodiment;

FIG. 4 is a schematic graph explaining a change in time-based variation amount of a flow and an operation relating to a diagnosis in the first embodiment;

FIG. 5 is a schematic diagram showing a mass flow controller and a diagnostic device according to a second embodiment of the present invention;

FIG. 6 is a schematic graph explaining a change in time-based variation amount of a pressure and an operation relating to a diagnosis in the second embodiment; and

FIG. 7 is a schematic diagram showing a mass flow controller and a diagnostic device according to a third embodiment of the present invention.

### DESCRIPTION OF REFERENCE CHARACTERS

100 . . . Mass flow controller (flow rate control device)
200 . . . Diagnostic device
1 . . . Thermal type flow rate sensor (flow rate measuring mechanism)
13 . . . Laminar flow element
2 . . . Flow rate control valve
21 . . . Valve control part
3 . . . Pressure sensor
4 . . . Fluid resistor
5 . . . Stable state judging part
6 . . . Abnormality diagnosing part
61 . . . Flow rate variation amount calculating part
62 . . . Abnormality judging part
63 . . . Pressure variation amount calculating part

### Description of the Embodiments

The following describes a flow rate control device and a diagnostic device 200 according to the first embodiment of the present invention, referring to the accompanying drawings.

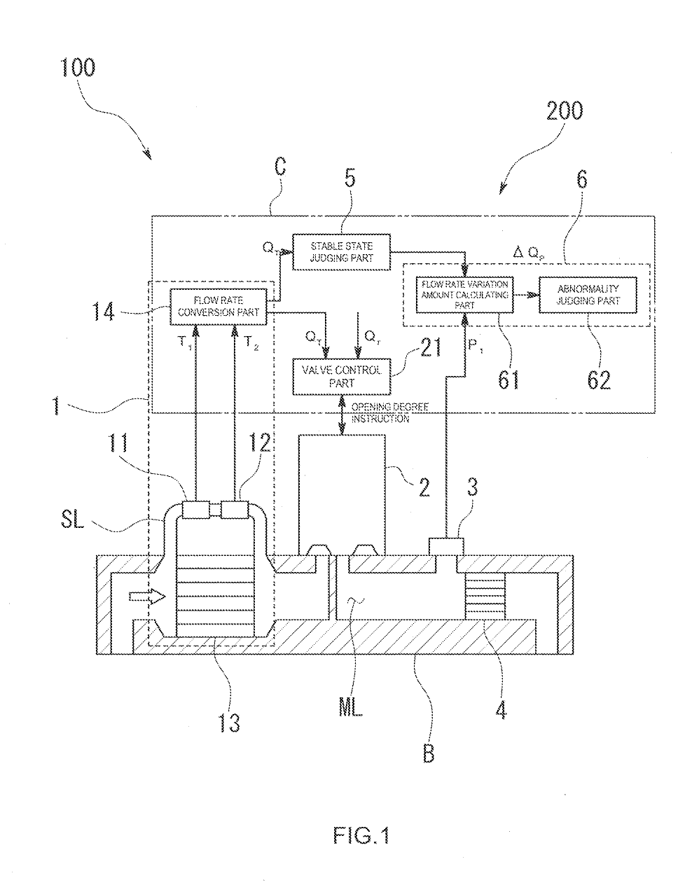

The flow rate control device of the first embodiment is configured by a mass flow controller 100 which is used for supplying a process gas containing raw materials required for deposition in a chamber such as a chemical vapor deposition (CVD) device, for example, in semiconductor manufacture. As shown in a schematic view of FIG. 1, the mass flow controller 100 is configured to have a flow channel ML which is formed by forming a through path inside a block body B of a substantially rectangular parallelepiped shape, wherein equipment for controlling fluid and various kinds of equipment for constituting the diagnostic device 200 are attached to an upper surface of the block body B so that the mass flow controller 100 is packaged.

More specifically, the mass flow controller 100 includes a flow rate measuring mechanism, a flow rate control valve 2, a pressure sensor 3 and a fluid resistor 4 which are provided on or in the flow channel ML formed inside the block body B in this order from the upstream side, and further includes a calculating part C for performing various calculations for controlling and diagnosing each equipment. And, the mass flow controller 100 controls an opening degree of the flow rate control valve 2 so as to reduce an error between a target flow rate value Qᵣ and a measurement flow rate value Q_{T} measured by the flow rate measuring mechanism to thereby supply a desired flow rate into the chamber.

Each part is described referring to FIG. 1. First, a hardware configuration is mainly described.

As shown in FIG. 1, the block body B includes a fluid introduction port for introducing the fluid into the inside flow channel ML and a fluid derivation port for deriving the fluid of which the flow rate is controlled, wherein the fluid introduction port and the fluid derivation port are opening in a lower surface of the block body B. In an upper surface thereof, attachment holes are formed for attaching the flow rate measuring mechanism, flow rate control valve 2 and pressure sensor 3, and for communicating with the flow channel ML.

The flow rate measuring mechanism is configured to measure a flow rate of fluid flowing inside the block body B, and a thermal type flow rate sensor 1 is used for the flow rate measuring mechanism in the first embodiment. This thermal type flow rate sensor 1 includes: a laminar flow element 13 provided in the flow channel ML; a sensor flow channel SL which is a metal fine tube formed to have a substantially inverted U-character shape and which branches from the flow channel ML upstream of the laminar flow element 13 and joins to the flow channel ML downstream of the laminar flow element 13; a first temperature sensor 11 and a second temperature sensor 12 respectively provided in the upstream side and downstream side on the outside of the metal fine tube forming the sensor flow channel SL; and a flow rate conversion part 14 converting a flow rate flowing through the flow channel ML based on a temperature difference measured by the first and second temperature sensors 11 and 12. It is noted that the flow rate conversion part 14 is constructed using a calculating function of the calculating part C, to be described later, so that the measurement flow rate value Q_{T} is calculated based on the following Expression 1.

Q_{T}=k_{T}(T₁−T₂) Expression (1)

Herein, Q_{T} is a measurement flow rate value, k_{T} is a conversion factor from a temperature difference to a flow rate, T₁ is an upstream side temperature measured by the first temperature sensor 11, and T₂ is a downstream side temperature measured by the second temperature sensor 12.

The laminar flow element 13 is configured to divert the fluid from the flow channel ML to the sensor flow channel SL at a predetermined diverting ratio, and it is formed by, for example, laminating thin plates in which minute through grooves are formed. That is, a length and a depth of each of the through grooves are set so that the fluid flows in a laminar flow state when passing through the laminar flow element 13. Since the laminar flow element 13 has such a micro-structure, in some cases, products from the process gas passing through the laminar flow element 13 may attach to the micro-structure of the through grooves and the like and cause clogging. Moreover, since the sensor flow channel SL is also constituted of a metal fine tube, clogging may also occur there as well. And, if clogging occurs in the laminar flow element 13 or the sensor flow channel SL, the diverting ratio is changed, and therefore the temperature difference measured by the first and second temperature sensors 11 and 12 does not reflect an actual flow rate, which results in occurrence of an abnormality in the measurement flow rate value Q_{T} measured by the thermal type flow rate sensor 1.

The flow rate control valve 2 is, for example, a piezo valve of which an opening degree is controlled by a valve control part 21 to be described later.

The fluid resistor 4 is configured to cause a pressure difference between the upstream side and the downstream side thereof; for example, a fluid resistor having a structure similar to that of the laminar flow element 13 or an orifice may be used.

The pressure sensor 3 is configured to measure a pressure between the flow rate control valve 2 and the fluid resistor 4, in the upstream side of the fluid resistor 4. In a different way of viewing the fluid resistor 4 and the pressure sensor 3, this pressure type flowmeter configuration retains only the pressure sensor 3 in the upstream side, while a pressure sensor in the downstream side is omitted.

Next, a software configuration is mainly described.

The calculating part C is configured in a manner that its function is implemented by, for example, a computer or microcomputer provided with a CPU, a memory, an I/O interface, A/D and D/A converters and the like, and that functions as at least a valve control part 21, a stable state judging part 5, and an abnormality diagnosing part 6, and is executed by carrying out a program stored in the memory. It is noted that, in the first embodiment, the diagnostic device 200 includes the pressure sensor 3, the fluid resistor 4, the stable state judging part 5 and the abnormality diagnosing part 6.

Each part is described below.

The valve control part 21 is configured to control an opening degree of the flow rate control valve 2 so as to reduce an error between the measurement flow rate value Q_{T} calculated by the thermal type flow rate sensor 1 and the target flow rate value Qᵣ. More specifically, if the measurement flow rate value Q_{T} is fed back, the error with respect to the target flow rate value Qᵣ is calculated so as to change a voltage to be applied to the flow rate control valve 2 in accordance with the error. It is noted that the target flow rate value Qᵣ may be an instruction value previously inputted as a program or may be sequentially inputted by an external input. In the first embodiment, as the target flow rate value Qᵣ, a step-like input value is inputted to the valve control part 21 for the purpose of continuing to hold a certain constant value for a predetermined time. For example, a value of a step input is changed every time a state of a process is switched.

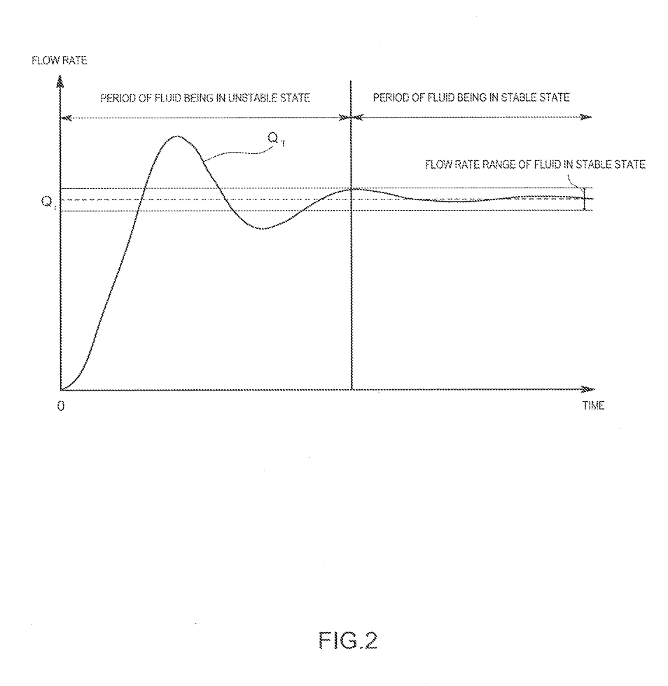

The stable state judging part 5 is configured to judge based on the measurement flow rate value Q_{T} whether or not a state of fluid flowing through the flow channel ML is in a stable state. More specifically, the stable state judging part 5 is configured such that, as shown in the graph of FIG. 2, in the case where a state of an absolute value of the error between the measurement flow rate value Q_{T} and the target flow rate value Qᵣ being equal to or smaller than a predetermined value is maintained for a predetermined time or more, the state of the fluid is judged to be in a stable state. Herein, the state of the fluid being in a stable state can also be said to mean a state wherein parameters relating to a flow rate such as a flow rate and a pressure of the fluid flowing through the flow channel ML are not largely varied with time, but are substantially kept constant. Further, in other words, it may be also said that “fluid being stable” means a state in which both or any one of the measurement flow rate value Q_{T} and the measured pressure value are within a range of a predetermined value and are continuously and substantially kept constant for a predetermined time. It is noted that the predetermined value and the predetermined time may be previously set at a time of factory-shipment, or a user may appropriately set the value.

The abnormality diagnosing part 6 is configured to diagnose an abnormality of the measurement flow rate value Q_{T} based on a time-based variation amount of the measurement pressure value P₁ in the case where the stable state judging part 5 judges the fluid to be in a stable state. More specifically, in the first embodiment, the abnormality diagnosing part 6 includes a flow rate variation amount calculating part 61 for calculating a variation amount ΔQ_{P} of a flow rate of fluid flowing through the flow channel ML based on a variation amount ΔP₁ of the measurement pressure value P₁, and an abnormality judging part 62 configured to judge that the measurement flow rate value Q_{T} is abnormal in the case where an absolute value of the variation amount ΔQ_{P} of the fluid calculated by the flow rate variation amount calculating part 61 becomes equal to or larger than a predetermined value.

The flow rate variation amount calculating part 61 is configured to calculate the variation amount ΔQ_{P} of the fluid in a stable state when a time lapse is At, based on a measurement pressure value P₁(t) at a predetermined time t and a measurement pressure value P₁(t+Δt) at a time (t+Δt) after a time lapse Δt from the predetermined time. More specifically, the flow rate variation amount calculating part 61 is configured to calculate the variation amount ΔQ_{P} of the fluid based on Expression 4 to be described later which is derived from a flow rate calculating formula of Expression 2 based on pressure values.

Q_{P}=k_{P}(P₁²−P₂²) Expression (2)

Herein, Q_{P} is a flow rate value calculated based on a pressure, k_{P} is a conversion factor from a pressure judged by the fluid resistor 4 to a flow rate, P₁ is a measurement pressure value in the upstream side of the fluid resistor 4 measured by the pressure sensor 3, and P₂ is a pressure value in the downstream side of the fluid resistor 4, wherein P₂ is an unmeasured value in the present embodiment and therefore it is an unknown quantity. As is apparent from the Expression 2, the flow rate variation amount calculating part 61 is configured to calculate the variation amount ΔQ_{P} of the fluid based on a relationship between the flow rate and the pressure.

In Expression 2, the pressure value P₂ in the downstream side of the fluid resistor 4 is unknown and it is not possible to proceed with the calculation. Therefore, for example, considering the time-based variation amount ΔQ_{P} after a time lapse of only Δt, ΔQ_{P} can be transformed as shown by Expression 3.

ΔQ_{P}=Q_{P}(t+Δt)−Q_{P}(t)=k_{P}(P₁(t+Δt)²−P₁(t)²−P₂(t+Δt)²+P₂(t)²)=k_{P}(ΔP₁(P₁(t+Δt)+P₁(t))−ΔP₂(P₂(t+Δt)+P₂(t)) Expression (3)

Herein, ΔP₁=P₁(t+Δt)−P₁(t), ΔP₂=P₂(t+Δt)−P₂(t), and ΔP₁ is a variation amount of the pressure in the upstream side of the fluid resistor 4, and ΔP₂ corresponds to a variation amount of the pressure in the downstream side of the fluid resistor 4.

Moreover, while the fluid is judged to be in a stable state by the stable state judging part 5, since there is little variation in the flow rate of the fluid, the pressure in the downstream side of the fluid resistor 4 is lower compared to the pressure in the upstream side so that the flow rate of the fluid is substantially stable, and hence ΔP₂ can be regarded as substantially zero. Therefore, since the second term of Expression 3 described based on the pressure in the downstream side can be ignored, ΔQ_{P} calculated by Expression 3 can be eventually approximated as shown by Expression 4 with good accuracy assuming that the fluid is in a stable state.

ΔQ_{P}=k_{P}(ΔP₁(P₁(t+Δt)+P₁(t)) Expression (4)

Herein, since P₁ is a value measured by the pressure sensor 3, all of the values in this Expression 4 are known, and hence the flow rate variation amount calculating part can calculate the flow rate variation amount ΔQ_{P} at a time lapse of only Δt from a certain time t. In this manner, measurement of pressure value P1 via the pressure sensor 3 not only enables calculation of an actual flow rate Q_{P} at a certain time t, but also renders a flow rate variation amount measurable, and hence the calculations regarding the flow rate can he performed using measurements from only a single pressure sensor 3.

In the case where the absolute value of the flow rate variation amount ΔQ_{P} calculated by the flow rate variation amount calculating part is larger than a predetermined value, the abnormality judging part 62 judges that an abnormality occurs in the measurement flow rate value Q_{T}. Herein, the predetermined value is a value set based on an acceptable flow rate error and it is set to, for example, 1% etc. of the target flow rate value Qᵣ. In this way, since a quantitative evaluation is performed based on the flow rate variation amount ΔQ_{P}, it is configured to determine not only whether or not an abnormality occurs in the measurement flow rate value Q_{T}, but also what degree of a flow rate error is caused by the abnormality so that the abnormality determination is performed only when the flow rate error becomes unacceptable. it is noted that the predetermined value described here may be also appropriately set by a user according to for example, a particular usage state.

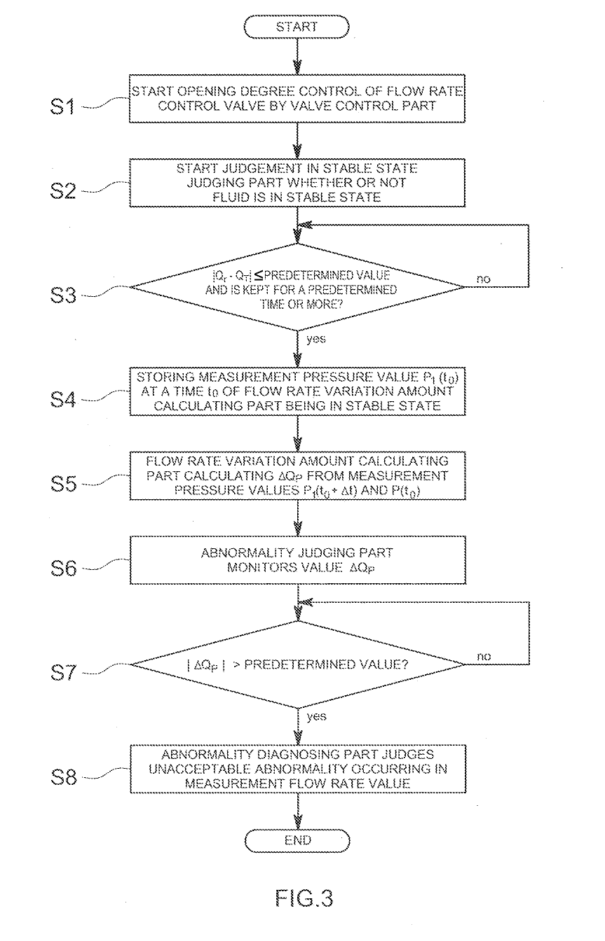

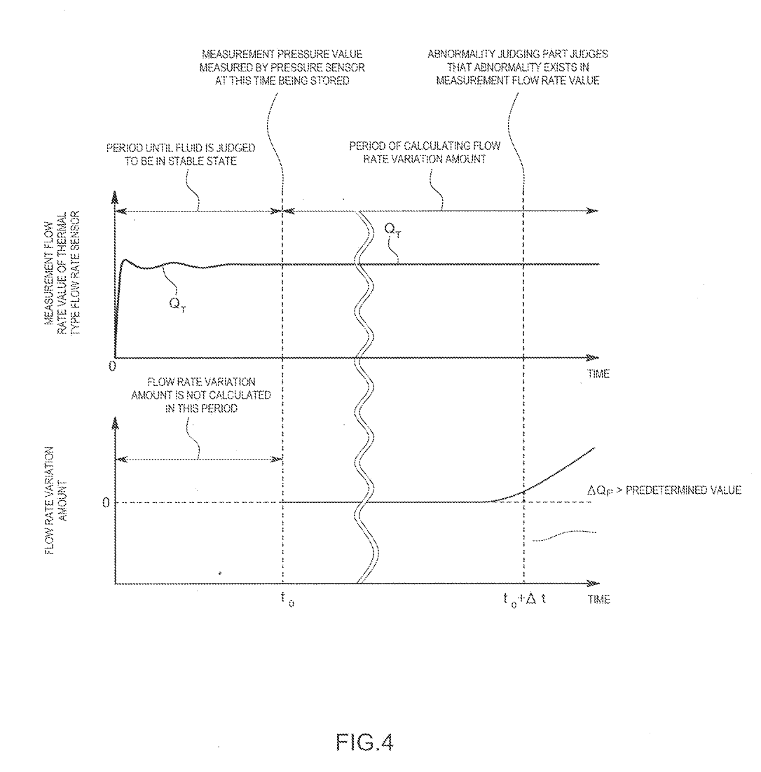

An operation concerning a diagnosis of the measurement flow rate value Q_{T} of the mass flow controller 100 configured as described above will be described referring to the flow chart in FIG. 3 and the graph in FIG. 4.

First, the control of the opening degree of the flow rate control valve 2 is started by the valve control part 21 in a manner that an error between a measurement flow rate value Q_{T} measured by the thermal type flow rate sensor 1 and a target flow rate value Qᵣ is reduced (Step S1). When the flow rate control is started, the stable state judging part 5 starts a determination whether or not the fluid is in a stable state (Step S2). In the case where a state of the error between the measurement flow rate value Q_{T} and the target flow rate value Qᵣ is equal to or smaller than a predetermined value, and is maintained as such for a predetermined time or longer, the stable state judging part 5 judges the state to be stable (Step S3). The flow rate variation amount calculating part 61 stores, in an initial pressure storage part (not shown), a measurement pressure value P₁(t₀) measured by the pressure sensor 3 at a time when the state is judged to be stable (Step S4). Herein, the measurement pressure value P₁(t₀) stored in the initial pressure storage part is maintained until the stable state of the fluid is lost. For example, the measurement pressure value P₁(t₀) may be updated and stored in the case where the state of the fluid becomes stable again after the stable state is lost, or it may be updated and stored after every predetermined time interval. Thus, based on the measurement pressure value P₁(t₀+Δt) at a time (t₀+Δt) after a time lapse of only Δt from a time t₀ and the measurement pressure value P₁(t₀) stored in the initial pressure storage part, the flow rate variation amount calculating part 61 sequentially continues to calculate the flow rate variation amount ΔQ_{P} from Expression 4 (Step S5). The calculation of this flow rate variation amount ΔQ_{P} is performed, for example, in accordance with a sampling period of the pressure sensor 3, Then, after the time-based flow rate variation amount ΔQ_{P} is to be calculated by the flow rate variation amount calculating part 61, the abnormality judging part 62 continues to monitor whether or not the absolute value of the corresponding time-based flow rate variation amount ΔQ_{P} becomes larger than the predetermined value (Step S6). In the case where the time-based flow rate variation amount ΔQ_{P} becomes larger than the predetermined value (Step S7), the abnormality judging part 62 judges that there occurs an abnormality equal to or larger than an acceptable value in the measurement flow rate value Q_{T} measured by the thermal type flow rate sensor 1 and fed back to the flow rate control valve 2 (Step S8). If an occurrence of an abnormality is judged by the abnormality diagnosing part 6, for example, maintenance work such as checking the parts of the thermal type flow rate sensor 1, and checking for clogging of the device, etc. can be carried out by workers.

In order to configure a conventional pressure type flowmeter for comparison to the thermal type flow rate sensor 1, pressure sensors 3 are inherently provided in both of the upstream and downstream sides of the fluid resistor 4, whereas according to the mass flow controller 100 and diagnostic device 200 of the first embodiment configured as described above, the pressure sensor 3 is attached to only one of the upstream and downstream sides so that an abnormality of the measurement flow rate value Q_{T} can be diagnosed while reducing the number of parts, especially, the number of sensors. Moreover, when a state of fluid flowing through the flow channel ML is in a stable state, since the time-based flow rate variation amount ΔQ_{P} is calculated based on the measurement pressure value P₁, an accurate value can be calculated, despite reducing the number of sensors. Therefore, the time-based flow rate variation amount ΔQ_{P} can be used as a criteria for diagnosing an abnormality of the measurement flow rate value Q_{T} to be measured by the thermal type flow rate sensor 1 so as to be able to perform a quantitative evaluation, for example, determining to what degree a flow rate error is caused by an abnormality. For this reason, occurrence of an abnormality is found not by a rough diagnosis, but rather by a precise evaluation such that, when a disturbance occurs, it is not regarded as an abnormality if it is within an acceptable range, wherein a diagnosis can be performed in accordance with a predetermined.

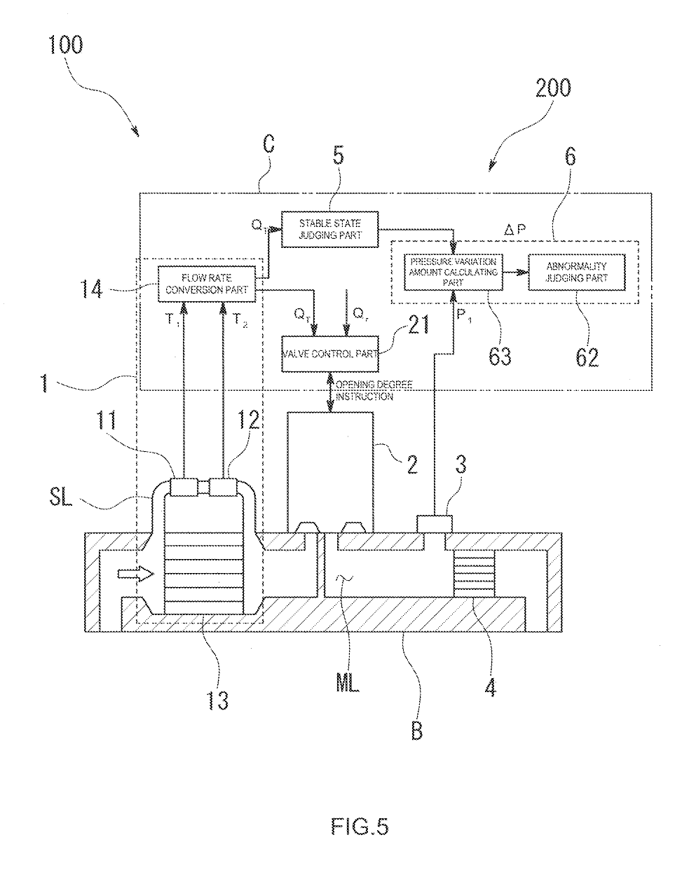

Next, the second embodiment of the present invention is described referring to FIG. 5. Like members and parts corresponding to those in the first embodiment are designated by the same reference numerals.

Whereas the abnormality diagnosing part 6 is configured to diagnose, based on the flow rate variation amount ΔQ_{P} whether or not an abnormality occurs in the measurement flow rate value Q_{T} of the thermal type flow rate sensor 1 in the first embodiment, the abnormality diagnosing part 6 of the second embodiment is configured to diagnose an abnormality of the measurement flow rate value Q_{T} based on a variation amount of a measurement pressure value P₁.

That is, in the mass flow controller 100 and diagnostic device 200 of the second embodiment, the abnormality diagnosing part 6 includes a pressure variation amount calculating part 63 for calculating a variation amount of the measurement pressure value and an abnormality judging part 62 configured to judge the measurement flow rate value to be abnormal in the case where an absolute value of the variation amount of the pressure calculated by the pressure variation amount calculating part 63 is equal to or larger than a predetermined value.

The pressure variation amount calculating part 63 is configured to sequentially calculate a variation amount as to the measurement pressure value P₁ measured by the pressure sensor 3 when the fluid is in a stable state. In the second embodiment, the pressure variation amount calculating part 63 is configured to calculate a difference as a variation amount as in the first embodiment. More specifically, the pressure variation amount calculating part 63 is configured to render the measurement pressure value P₁ at a certain time to be stored and held in the initial pressure storage part so as to be able to sequentially calculate a difference between the measurement pressure value P₁ based on the stored measurement pressure value P₁ at a certain time and a currently measured measurement pressure value P₁ and to continuously output the calculated difference value. For example, it may be also possible to sequentially calculate a difference between adjacent values of the measurement pressure value P₁ based on time-series data of the measurement pressure value P₁ without storing an initial pressure value.

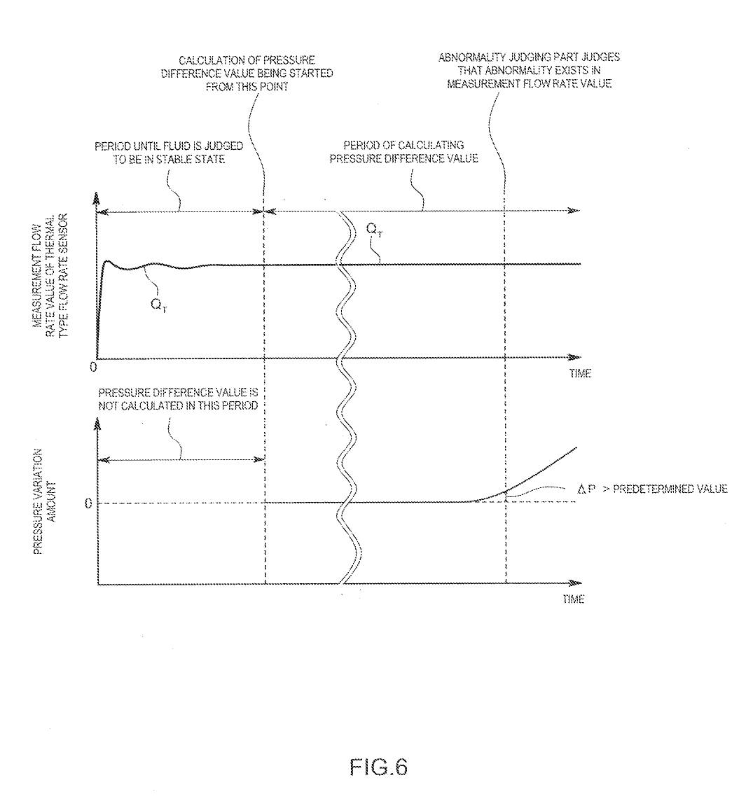

According to the mass flow controller 100 and diagnostic device 200 of the second embodiment configured as described above, as shown in the graph of FIG. 6, after the fluid is judged to be in a stable state by the stable state judging part 5, the pressure variation amount calculating part 63 starts calculating the difference between the measurement pressure value P₁ at the time of determination of the fluid being in the stable state and the measurement pressure value P₁ currently measured by the pressure sensor 3, and in the case where an absolute value of the difference value ΔP of the measurement pressure values becomes larger than a predetermined value, the abnormality judging part 62 judges that there occurs an abnormality in the measurement flow rate value Q_{T}.

That is, according to the mass flow controller 100 and diagnostic device 200 of the second embodiment, it can be known from the variation amount of the measurement pressure value P₁ measured by the pressure sensor 3 that, for example, clogging occurs in the thermal type flow rate sensor 1, and an error appears in the outputted measurement flow rate value Q_{T}.

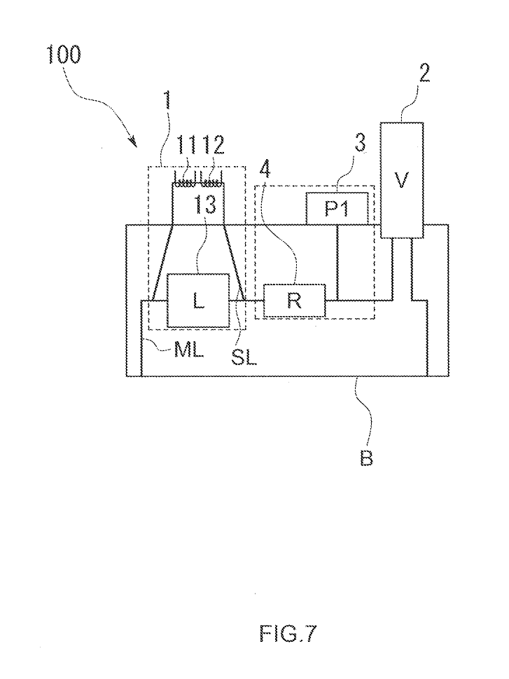

Next, the third embodiment of the present invention is described referring to FIG. 7. It is noted that like members and parts corresponding to those in the first embodiment are designated by the same reference numerals. Although the pressure sensor 3 is provided only in the upstream side of the fluid resistor 4, the pressure sensor 3 may alternately be provided only in the downstream side so that an unknown pressure in the upstream side of the fluid resistor 4 may be calculated by the pressure calculating part 6. Even with this configuration, an abnormality occurring in the measurement flow rate value Q_{T} can be quantitatively diagnosed with high accuracy similarly to the mass flow controller 100 of the first embodiment In addition, as shown in the second embodiment, the thermal type flow rate sensor 1, fluid resistor 4, pressure sensor 3 and flow rate control valve 2 may be provided in this order from an upstream of the flow channel ML. That is, the order of the flow rate measuring mechanism, flow rate control valve 2, pressure sensor 3 and fluid resistor 4 arranged along the flow channel ML is not especially limited.

Other embodiments will be described below.

In each of the above embodiments, although the flow rate control device configured as the mass flow controller is exemplified, a similar flow rate control device may be configured without packaging each of the parts. In addition, by installing a diagnostic program for executing functions as the stable state judging part, pressure calculating part, flow rate calculating part and abnormality diagnosing part from, for example, a recording medium to a computer constituting an existing mass flow controller, a diagnostic performing configuration may be added. Moreover, a flow rate measuring mechanism such as a thermal type flow rate sensor or a pressure type flow rate sensor as a single body is provided on a flow channel, and it may be also possible to diagnose using the diagnostic device whether or not an abnormality occurs in a measurement flow rate value measured by the flow rate measuring mechanism.

The flow rate measurement mechanism is not limited to a thermal type flow rate sensor, or other pressure type sensor, and a sensor using another measurement principle may be used. In addition to adapting the stable state judging part to judge whether or not a fluid state is stable based on an error between a measurement flow rate value and a target flow rate value, for example, it may be also possible to configure the stable state judging part to judge whether or not a fluid state is stable based on a pressure value measured by the pressure sensor. Although the abnormality diagnosing part is configured to diagnose whether or not an abnormality occurs in the measurement flow rate value, for example, it may also be configured to diagnose a cause of an occurrence of an abnormality in the measurement flow rate value. The fluid resistor may be a laminar flow element of the thermal type flow rate sensor. For example, instead of providing the laminar flow element and the fluid resistor separately in the flow channel, these may be provided in common. In this case, it may be sufficient to provide the pressure sensor in any of the upstream side or downstream side of the laminar flow element. In addition, the calculating Expression 4 of a flow rate shown in the above embodiments is merely one example, and an alternate appropriate calculating expression may be used in accordance with, for example, a particular usage condition. Furthermore, although the pressure variation amount calculating part of the second embodiment is configured to calculate a difference in pressure, it may be configured to calculate a differential value as the variation amount.

In each of the above embodiments, the time-based flow rate variation amount may be a difference value or a differential value. Similarly, as to a time-based pressure variation amount, it may be a difference value or a differential value. In sum, it may be sufficient to use an appropriate value for detecting, for example, clogging occurring in the flow rate measuring mechanism, by determining that a pressure value or an actual flow rate is varying in spite of the flow rate being kept constant, thereby detecting that an abnormality is occurring in the flow rate measurement value.

In addition, the embodiments of the present invention may be combined and various changes and modifications can be made unless departing from the intended spirit thereof.

### INDUSTRIAL APPLICABILITY

Thus, according to the flow rate control device, a diagnostic device for use in a flow rate measuring mechanism or for use in the flow rate control device which includes the flow rate measuring mechanism and the recording medium having a diagnostic program recorded thereon for use in the same of the present invention, as a configuration for diagnosing an abnormality, it is sufficient to provide only one sensor other than the flow rate measuring mechanism for outputting a measurement flow rate value to be used in the feedback control. Hence, the number of parts can be reduced so as to suppress the increase of the manufacturing cost. In addition, since the diagnosis of an abnormality of the measurement flow rate value is performed based on a variation amount of the measurement pressure value when fluid is in a stable state, it becomes possible to diagnose an abnormality of the measurement flow rate value with an accuracy equal to or higher than a conventional sensor configuration even in the case where the number of the diagnostic sensors is smaller than that in the conventional configuration.

1. A flow rate control device including a flow rate measuring mechanism configured to measure a flow rate of fluid flowing through a flow channel, a flow rate control valve provided on the flow channel, and a valve control part configured to control an opening degree of the flow rate control valve so as to reduce an error between a target flow rate value and a measurement flow rate value measured by the flow rate measuring mechanism, the flow rate control device comprising:
a fluid resistor provided on the flow channel;
a pressure sensor provided in any one of an upstream side or a downstream side of the fluid resistor;
a stable state judging part configured to judge whether or not a state of the fluid flowing through the flow channel is in a stable state, based on the measurement flow rate value or a measurement pressure value measured by the pressure sensor; and
an abnormality diagnosing part configured to diagnose an abnormality of the measurement flow rate value, based on a variation amount of the measurement pressure value, when the stable state judging part judges that the state of the fluid is in the stable state.

2. The flow rate control device according to claim 1, wherein the abnormality diagnosing part includes:
a pressure variation amount calculating part configured to calculate a variation amount of the measurement pressure value; and
an abnormality judging part configured to judge that the measurement flow rate value is abnormal when an absolute value of the variation amount of the pressure calculated by the pressure variation amount calculating part is equal to or larger than a predetermined value.

3. The flow rate control device according to claim 1, wherein the abnormality diagnosing part includes:
a flow rate variation amount calculating part configured to calculate a variation amount of the flow rate of the fluid flowing through the flow channel based on variation amount of the measurement pressure value; and
an abnormality judging part configured to judge that the measurement flow rate value is abnormal in when an absolute value of the variation amount of the flow rate calculated by the flow rate variation amount calculating part is equal to or larger than a predetermined value.

4. The flow rate control device according to claim 1, wherein the stable state judging part is configured to judge that the state of the fluid is in a stable state when a state of an absolute value of the error between the measurement flow rate value and the target flow rate value being equal to or smaller than a predetermined value continues for a predetermined time period or more.

5. The flow rate control device according to claim 1, wherein the flow rate measuring mechanism is a thermal type flow rate sensor.

6. The flow rate control device according to claim 5, wherein the thermal type flow rate sensor includes a laminar flow element provided on the flow channel and the fluid resistor is provided separately from the laminar flow element.

7. A diagnostic device for use in a flow rate measuring mechanism configured to measure a flow rate of fluid flowing through a flow channel or in a flow rate control device including the flow rate measuring mechanism, the diagnostic device comprising:
a fluid resistor provided on the flow channel;
a pressure sensor provided in any one of an upstream side or a downstream side of the fluid resistor;
a stable state judging part configured to judge whether or not a state of the fluid flowing through the flow channel is in a stable state, based on a measurement flow rate value or a measurement pressure value measured by the pressure sensor; and
an abnormality diagnosing part configured to diagnose an abnormality of the measurement flow rate value based on a variation amount of the measurement pressure value when the stable state judging part judges that the state of the fluid is in the stable state.

8. A diagnostic program for use in a flow rate control device including a flow rate measuring mechanism including a fluid resistor provided on a flow channel and a pressure sensor provided in any of an upstream side or a downstream side of the fluid resistor, and measuring a flow rate of fluid flowing through the flow channel, the diagnostic program comprising:
a stable state judging part configured to judge whether or not a state of the fluid flowing through the flow channel is in a stable state, based on a measurement flow rate value or a measurement pressure value measured by the pressure sensor; and
an abnormality diagnosing part configured to diagnose an abnormality of the measurement flow rate value based on a variation amount of the measurement pressure value when the stable state judging part judges that the state of the fluid is in the stable state.
